(19) United States
(12) Patent Application Publication
(10) Pub. No.: US 2014/0231261 A1
(43) Pub. Date: Aug. 21, 2014

(54) DIALYZER CLAMP

(71) Applicant: AGC ENGINEERING CO., LTD., Chiba-shi (JP)

(72) Inventors: Yukio Matsumura, Chiba (JP); Shuichi Ohkawa, Chiba (JP); Tadao Yuki, Chiba (JP); Kazumi Ohshima, Chiba (JP); Kouji Nobuta, Chiba (JP); Taigo Ohsawa, Chiba (JP); Kazuo Kitamura, Chiba (JP)

(73) Assignee: AGC ENGINEERING CO., LTD., Chiba-shi (JP)

(21) Appl. No.: 14/262,431

(22) Filed: Apr. 25, 2014

Related U.S. Application Data
(63) Continuation of application No. PCT/JP2012/077794, filed on Oct. 26, 2012.

(30) Foreign Application Priority Data
Oct. 28, 2011 (JP) 2011-237134

(51) Int. Cl. C02F 1/469

(52) U.S. Cl. CPC C02F 1/4693; B01D 2313/025
USPC 204/627

(57) ABSTRACT

A clamping device for a dialyzer includes a holding member having a supply port and a discharge port for permitting a liquid to be treated to flow through the desalination chambers and the concentration chambers; a clamping member for clamping the holding member by a certain clamping pressure; a lattice structure having a contact portion configured to be brought into contact with an electrode frame or be brought into contact with an electrode frame through a certain plate-shaped member such that the clamping member clamps the electrode frame, the chamber frames and the exchange membranes through the contact portion by tightening the clamping members; and the lattice structure having a pitch width of at least 10 mm and at most 50 mm.

### TECHNICAL FIELD

The present invention relates to a clamping device for a dialyzer, in particular, a clamping device for a dialyzer, which is readily produced, has stable and excellent performance and quality, is inexpensive and lightweight and is excellent in handling.

### BACKGROUND ART

There has been known an electrodialyzer which carries out desalination and concentration, utilizing a DC current as a driving power source.

Such an electrodialyzer is configured to have many anion exchange membranes and many cation exchange membranes disposed alternately with a chamber frame interposed between adjacent anion and cation exchange membranes and have electrodes disposed on both ends thereof so as to form desalination chambers and concentration chambers between the respective ion membranes as shown in, e.g. Patent Document 1 listed below. The unit of the chamber frames and the ion membranes thus stacked has an anode and a cathode as electrodes disposed on both ends thereof and has clamping devices disposed on both outermost sides thereof. In FIG. 1 of Patent Document 1 (shown as FIG. 9 in this application), a dialysis-functional unit 40, which has the anion exchange membranes and the cation exchange membranes disposed alternately through spacers and the chamber frames between both electrodes so as to form the desalination chambers, the concentration chambers and the electrode chambers, has clamping frames 41 disposed on both ends thereof and is fixedly clamped by clamping bolts 42, nuts 43 and springs 44 (see Patent Document 1).

Each of the clamping frames (the wording “clamping frames” are also referred to as “clamping devices” in this Description) needs to have a thickness suited to a clamping pressure in order to suppress a deflection in chamber frames or other members during clamping and includes an iron plate having a thickness of, e.g. 30 mm to 50 mm as well as an enough size to cover electrode surfaces. The iron plates are clamped at peripheral portions thereof by bolts and nuts such that peripheral portions of the chamber frames is subjected to a pressure of 0.5 MPa to 1.4 MPa.

Each of the clamping frames has ribs vertically formed on the iron plate thereof for enforcement in order to have an increased strength, which is helpful to reduce the weight with a required strength kept.

### PRIOR ART DOCUMENT

### Patent Document

Patent Document 1: JP-A-2001-276580

### DISCLOSURE OF INVENTION

### Technical Problem

It is an actual situation that the conventional clamping devices for an electrodialyzer are so heavy as to be required to be handled by means of a crane during assembling and disassembling an electrodialyzer.

The conventional clamping devices for an electrodialyzer are difficult to be produced and are expensive because of needing to machine thick members and weld the enforcing ribs for production.

The present invention has been proposed, taking into account the above-mentioned conventional problems. It is an object of the present invention to provide a clamping device for a dialyzer, which is readily produced, has stable and excellent quality, is inexpensive and lightweight and is excellent in handling.

### Solution to Problem

The present invention provides a clamping device for a dialyzer, which is usable in an electrodialyzer (“electrodialyzer” is also simply referred to as “dialyzer” in this Description) including chamber frames and ion exchange membranes forming desalination chambers and/or concentration chambers (“ion exchange membranes” are also simply referred to as “exchange membranes” in this Description), and electrode frames for sandwiching the chamber frames and the exchange membranes therebetween;

the clamping device including:

a holding member having a supply port and a discharge port for permitting a liquid to be treated to flow through the desalination chambers and the concentration chambers;

a clamping part for clamping the holding member by a certain clamping pressure;

a lattice structure having a contact portion configured to be brought into contact with an electrode frame or be brought into contact with the electrode frame through a certain plate-shaped member such that the lattice structure clamps the electrode frame, the chamber frames and the exchange membranes through the contact portion by clamping at the clamping part; and

the lattice structure having a pitch width of at least 10 mm and at most 50 mm.

The lattice structure in the clamping device according to the present invention can be made lightweight because of adopting a lattice architecture for great strength. The lattice structure may be a commercially available grating which has been widely used and been versatile as a cover for rainwater ditches, a scaffold or a building material. For this reason, the clamping device according to the present invention is readily produced, has stable and excellent quality and is inexpensive.

In a preferred mode of the present invention, the holding member and the lattice structure are divided into plural sections, respectively, in other words, the clamping device is divided into plural section, preferably two sections.

By dividing the clamping device for an electrodialyzer into plural sections, it is possible to realize a further reduction in the weight. Thus, the clamping device is provided as a clamping device which can be handled without using a crane.

In a further preferred mode of the present invention, the clamping device is designed such that the chamber frames are subjected to a deflection of at most 1.5 mm when the clamping part applies a clamping pressure of at least 0.5 MPa.

Thus, it is possible to provide a clamping device for a dialyzer which is significantly more lightweight than the conventional clamping devices having a plate with ribs for reinforcement and secures a sufficient rigidity.

### Advantageous Effects of Invention

The clamping device for a dialyzer according to the present invention is configured to have a lattice structure, which clamps electrode frames, chamber frames and ion exchange membranes and has a pitch width of at least 10 mm and at most 50 mm. Thus, the clamping device can be provided with a strong strength and be made lightweight. The clamping device for a dialyzer according to the present invention can be readily produced, has a stable and excellent quality and is inexpensive because a commercially available grating can be unitized as the lattice structure.

### BRIEF DESCRIPTION OF DRAWINGS

FIG. 1 is a front view showing the entire structure of a clamping device for an electrodialyzer according to the present invention;

FIG. 2 is a front view of a right-hand clamping member of the chamber device;

FIG. 3 is a right side view of the right-hand clamping member;

FIG. 4 is a bottom view of the right-hand clamping member;

FIG. 5 is a cross-sectional view taken along line B-B and seen in the arrowed direction in FIG. 2;

FIG. 6 is a cross-sectional view taken along line A-A and seen in the arrowed direction in FIG. 2;

FIG. 7 is a simplified perspective view of a lattice structure according to the present invention;

FIG. 8 is a schematic view showing the structure of an electrodialyzer to which a pair of clamping devices for an electrodialyzer according to the present invention is applied; and

FIG. 9 is a schematic view of the electrodialyzer exemplified in Patent Document 1.

### DESCRIPTION OF EMBODIMENTS

Now, embodiments of the present invention will be described.

The clamping device for an electrodialyzer according to the present invention may be applied to, e.g. an electrodialyzer shown as a representative example in FIG. 8, which has many cation exchange membranes 50 and many anion exchange membranes 51 disposed vertically and alternately with a chamber frame for concentration 52 or a chamber frame for desalination 53 interposed between adjacent anion and cation exchange membranes so as to have the exchange membranes, the chamber frame for concentration and the chamber frames for desalination disposed between an electrode frame 54 as an anode side and an electrode frame 55 as a cathode side, has frame-shaped clamping members 56 and 56 disposed on both outer sides of the electrode frames 54 and 55, and has the exchange membranes, the chamber frame for concentration, the chamber frames for desalination and the electrode frames fixedly clamped by the clamping members 56 and 56. In FIG. 8, each of the electrode frames 54 and 55 is configured to fix an electrode so as to form an electrode chamber and to contain an electrolyte therein.

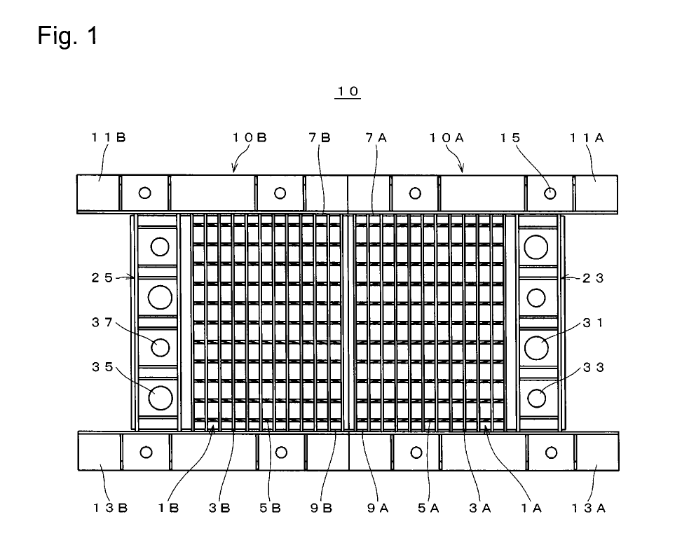

Now, reference will be made to FIG. 1, which is a front view showing the entire structure of the clamping device for an electrodialyzer according to an embodiment of the present invention.

The clamping device for an electrodialyzer shown in FIG. 1 is disposed so as to sandwich the dialyzer shown in FIG. 8 from both outer sides of the electrode frames. In other words, the clamping device shown in FIG. 1 may be normally utilized such that a right-hand part of the clamping device is disposed on a lower side of the dialyzer while a left-hand part of the clamping device is disposed on an upper side of the dialyzer. The clamping device for an electrodialyzer 10 is constituted by two symmetrical members of the right-hand clamping member 10A and a left-hand clamping member 10B, which preferably have the same structure as each other (i.e. the left-hand clamping member 10B has a reversed structure in comparison with the right-hand clamping member 10A).

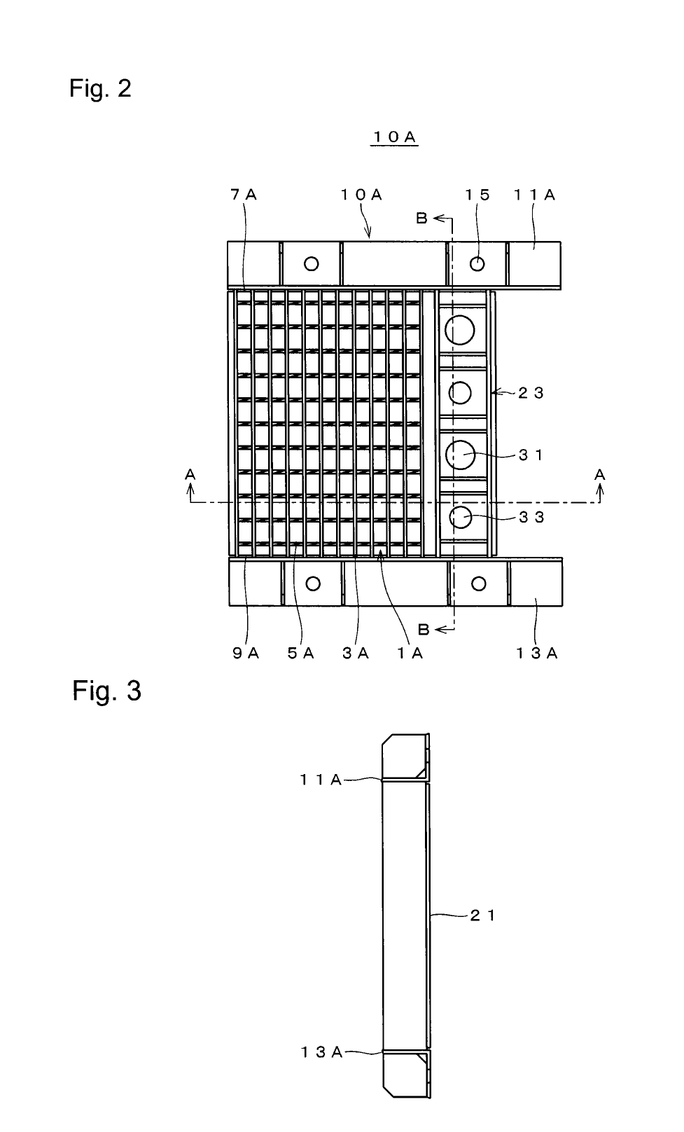

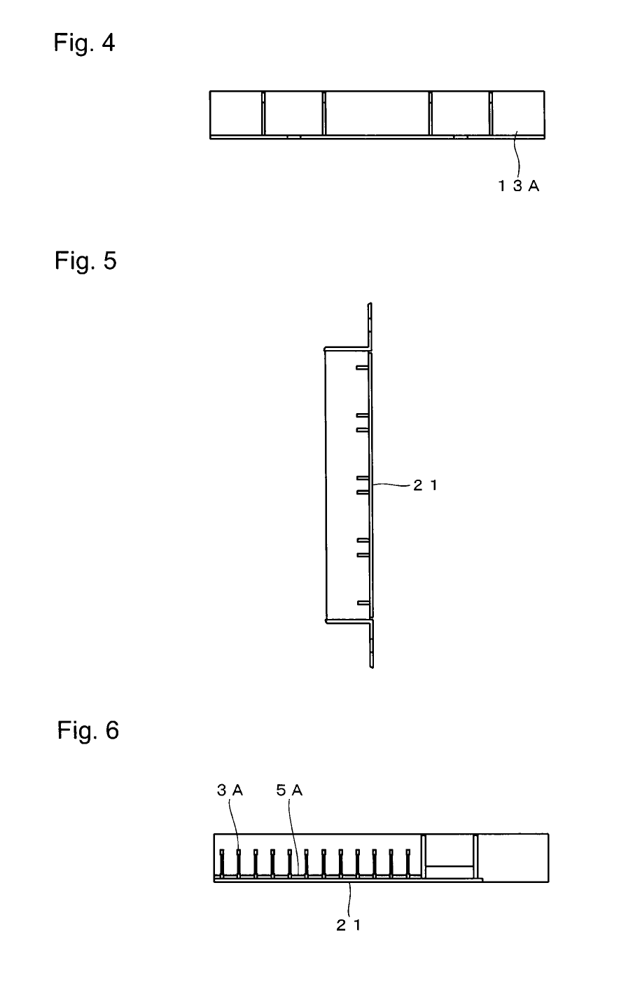

The clamping device for an electrodialyzer 10 is constituted by two symmetrical members of the right-hand clamping member 10A and a left-hand clamping member 10B. FIG. 2 is a front view of the right-hand clamping member 10A, FIG. 3 is a right side view of the right-hand clamping member 10A, and FIG. 4 is a bottom view of the right-hand clamping member 10A. FIG. 5 is a cross-sectional view taken along line B-B and seen in the arrowed direction in FIG. 2, and FIG. 6 is a cross-sectional view taken along line A-A and seen in the arrowed direction in FIG. 2. As described above, the above-mentioned right-hand clamping member 10A and left-hand clamping member 10B may be used such that the right-hand clamping member 10A is disposed on a lower side of the dialyzer (see FIG. 8) while the left-hand clamping member 10B is disposed on an upper side of the dialyzer. It should be noted that the above-mentioned right-hand clamping member 10A and left-hand clamping member 10B may be used such that the right-hand clamping member 10A is disposed on a right side of the dialyzer while the left-hand clamping member 10B is disposed on a left side of the dialyzer.

The right-hand clamping member 10A and the left-hand clamping member 10B have a lattice structure 1A and a lattice structure 1B, respectively.

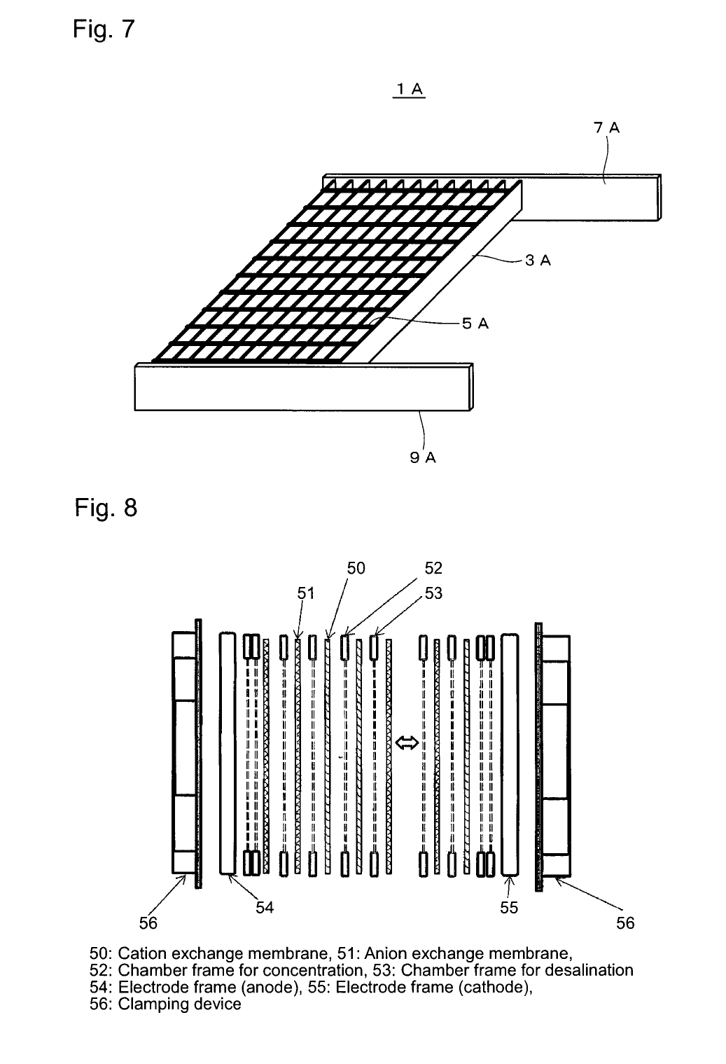

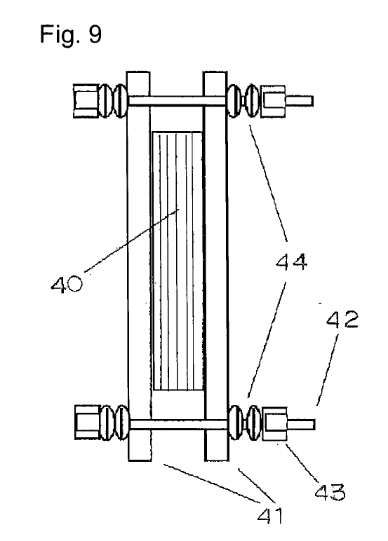

FIG. 7 is a schematic perspective view of the lattice structure 1A. It should be noted that the same structure is applied to the lattice structure 1B.

As shown in FIGS. 1 to 7, the lattice structures have a plurality of main bars 3A and 3B disposed with equal pitches in a lateral direction so as to extend toward the depth direction in FIGS. 1 and 2 and to be formed in a plate shape having a certain width. The lattice structures also have a plurality of crossbars 5A and 5B disposed with equal pitches in a longitudinal direction so as to extend toward the depth direction in FIG. 1, extend perpendicularly to and be welded to the main bars 3A and 3B, and to be formed in a bar shape or plate shape having a certain width, respectively. In the clamping device according to the present invention, the main bars 3A and 3B, and the crossbars 5A and 5B are disposed perpendicularly to each other to form the respective lattice structures. It should be noted that the lattice structures may be formed by disposing the main bars 3A and 3B, and the crossbars 5A and 5B to cross each other so as to form rhombic spaces therein.

Each of the main bars 3A and 3B has one end (an upper end in FIG. 1) fixed to an upper end plate 7A or 7B while each of the main bars 3A and 3B has the other end (an lower end in FIG. 1) fixed to a lower end plate 9A or 9B.

Each of the upper end plates 7A and 7B has an outer end (i.e. an outer right side and an outer left side in FIG. 1) welded to an L-shape of angled holding member 11A or 11B while each of the lower end plates 9A and 9B has an outer end (i.e. an outer right side and an outer left side in FIG. 1) welded to an L-shape of angled holding member 13A or 13B. Each of the L-shape of angled holding members 11A and 11B, and the L-shape of angled holding members 13A or 13B has a plurality of boltholes 15 formed therein.

The clamping part according to the present invention is surfaces of the holding members 11A, 11B, 13A and 13B facing the electrode frames, which sandwich the chamber frames and the exchange membranes forming the dialyzer. The clamping part is formed by a right-hand surface vertically extending in the sheet showing FIG. 3 and by a lower surface vertically extending in the sheet showing FIG. 4. In the clamping part, the entire dialyzer is clamped by the clamping device for a dialyzer according to the present invention by passing a plurality of bolts through the respective boltholes 15 and tightening the bolts.

The clamping device for a dialyzer according to the present invention may be brought into contact with holding members having a supply port and a discharge port for permitting a liquid to be treated to flow through the desalination chambers and concentration chambers and with the clamping part for clamping the holding members under a certain clamping pressure, and with the electrode frames or with the electrode frames through a certain plate-shaped member.

A plate-shaped member, which has a certain rigidity, may be additionally disposed on the surface of the clamping device for a dialyzer 10 facing an electrode frame in order to uniformly disperse the clamping pressure.

A mode of the present invention, where the clamping device for a dialyzer is brought into contact with holding members having a supply port and a discharge port for permitting a liquid to be treated to flow through the desalination chambers and concentration chambers and with the clamping part for clamping the holding members under a certain clamping pressure, and with the electrode frames through a certain plate-shaped member, is shown in FIGS. 3, 5 and 6 as an example. The plate-shaped member is shown as an iron plate 21 in these figures.

As shown in FIG. 6, the crossbars 5A and the crossbars 5B have the iron plate 21 mounted to bottom sides thereof. The iron plate 21 has a discharge side holding member 23 disposed to a right end thereof (a right end shown as a plan view of FIG. 1), and the discharge side holding member 23 has discharge ports for a desalinated liquid 31 and discharge ports for a concentrated liquid 33 formed therein such that the discharge ports for a concentrated liquid have an one-size smaller diameter than the discharge ports for a desalinated liquid. On the other hand, the iron plate 21 has a supply side holding member 25 disposed to a left end thereof (a left end shown as a plan view of FIG. 1), and the supply side holding member 25 has supply ports for a desalinated liquid 35 and supply ports for a concentrated liquid 37 formed therein such that the supply ports for a concentrated liquid have an one-size smaller diameter than the supply ports for a desalinated liquid.

Next, the operation of the embodiment of the present invention will be described.

As the lattice structure 1A and the lattice structure 1B, so-called gratings, which have been widely utilized as a cover for rainwater ditches, a scaffold or a building material, have been versatile, have been inexpensive and have been commercially available, are preferably utilized. The gratings are characterized in that they have a strong strength because of having a lattice structure.

Although gratings made of steel, gratings made of stainless steel, gratings made of rubber and gratings made of FRP are available, the gratings are preferably made of steel or stainless steel in terms of strength.

The strength as important required performance for the electrodialyzers is determined by the height of the main bars 3A and 3B and the pitches of them in a lateral direction.

Although the relationship between a clamping force and the deflection in a grating varies on the height of the main bars 3A and 3B and the pitches of them in a lateral direction, Table 1 shows comparison results that were obtained by comparing an iron plate having a thickness of 30 mm (comparative example) with lattice structures where gratings made of steel have main bars 3A and 3B with different heights and different lateral pitches were utilized (examples of the present invention) with regard to a deflection under a clamping force of 1.0 MPa. The gratings utilized in the examples had lattice pitches of 35 mm×40 mm. The main bars had a thickness of 6 mm, and the crossbars had a thickness of 6 mm.

Calculation was made under the condition that the total area of the L-shape of angled holding members 11A and 11B, the L-shape of angled holding member 13A and 13B, the discharge side holding members 23 and the supply side holding members 25 in the clamping device for an electrodialyzer having a width of 600 mm and a length of 1,400 mm were regarded as 0.24 m² indicating the area of the dialysis-functional part.

TABLE 1

| | Thickness | | | | | |
|---|---|---|---|---|---|---|
| | of | Grating (pitches of 35.3 mm) | | | | |
| | Iron Plate | Height of Main Bar (mm) | | | | |
| | 30 mm | 90 | 80 | 65 | 55 | 50 |
| Maximum | 1.49 | 0.19 | 0.27 | 0.48 | 0.79 | 1.04 |
| deflection | | | | | | |
| (mm) | | | | | | |
| Weight per unit | 236 | 118 | 107 | 88 | 75 | 69 |
| area (Kg/m²) | | | | | | |
| Stress (N/mm²) | 86 | 50 | 63 | 95 | 131 | 157 |

Table 1 reveals that when gratings, which had a maximum deflection at most equal to the conventional iron plate, are selected, the weight of each of the gratings can be reduced to at most one-third.

With regard to the allowable maximum stress, 180N/mm² is the reference value, and the main bars 3A and 3B should be selected such that a lower stress than this value is applied to the main bars. With regard to the deflection, when the deflection is beyond 1.5 mm, the stress is beyond 180N/mm². The acceptable deflection should be limited to at most 1.5 mm in terms of the acceptable stress as well. The main bars 3A and 3B have a height of preferably 40 mm to 100 mm, more preferably 50 mm to 75 mm, the most preferably 50 mm to 60 mm.

When gratings are utilized as the clamping device for an electrodialyzer 10 as described above, the clamping device for an electrodialyzer 10 is provided with an advantage of being significantly lightweight than conventional clamping devices for an electrodialyzer that have iron plates having a thickness of 30 mm to 50 mm and ribs formed on the iron plates for reinforcement and of providing chamber frames with a deflection of at most 1.5 mm when being clamped under a clamping pressure of at least 0.5 MPa. When the clamping device for an electrodialyzer 10 carries out clamping operation with a clamping pressure of at least 0.5 MPa, the deflection is preferably at most 1.5 mm.

Further, the total weight of the clamping device for an electrodialyzer 10 in an electrodialyzer is preferably at most 140 Kg because of being capable of being handled without using a crane when clamping the electrodialyzer.

In the present invention, the wording “pitch width of the lattice” means the pitches in a lateral direction and the pitches in a longitudinal direction.

It is sufficient in terms of the strength of the clamping device for an electrodialyzer 10 that the pitches in a lateral direction and the pitches in a longitudinal direction of the lattice bars in a lattice structure have a pitch width of at least 10 mm and at most 50 mm. It should be noted that the distance between the centers of adjacent lattice bars in a lateral direction is called a pitch width in such a lateral direction, and that the distance between the centers of adjacent lattice bars in a longitudinal direction is called a pitch width in such a longitudinal direction. Not only the pitches in a lateral direction but also the pitches in a longitudinal direction have a pitch width of preferably 10 mm to 50 mm. The bars forming the lattice have a thickness of preferably 4 mm to 10 mm.

When the clamping device for an electrodialyzer 10 is divided into two parts to be made more lightweight as shown in FIG. 1, preferably when the clamping device for an electrodialyzer 10 is divided into two upper and lower parts, the clamping device for an electrodialyzer 10 is made a clamping device capable of being handled without using a crane. When the clamping device for an electrodialyzer is configured as described just above, the clamping device for an electrodialyzer 10 is readily produced, and is provided with a stable and excellent quality and is inexpensive, lightweight and excellent in handing because of being capable of produced, making use of gratings as mass-produced products. It should be noted that the clamping device for an electrodialyzer 10 is not limited to be divided into two parts and may be divided into three parts.

Although it was concerned that when the clamping device for an electrodialyzer 10 is divided into more than two parts, the clamping state in the spacing between the divided parts was deteriorated, it was confirmed that no trouble was caused because an applied clamping force was dispersed and equalized by an electrode frame (made of a resin material and having a thickness of dozens of mm) adjoining to the clamping device for an electrodialyzer 10.

It should be noted that a plate member, which has a certain rigidity, may be additionally disposed on a side of the clamping device for an electrodialyzer 10 facing an electrode frame for pressure dispersion.

### EXAMPLE

Now, the present invention will be described in reference to an example. The present invention should be construed as being by no means restricted to the example.

### Example 1

Now, an example of the present invention will be described.

The gratings used as the lattice structure were products commercially available under the product name of “MO55-S” manufactured by DAIKURE CO., LTD and having main bars 3A and 3B of 55 mm in height as the basic structure, L-shape of angled holding members 11A, 11B, 13A and 13B having a width of 90 mm were welded to end plates 7A, 7B, 9A and 9B, and iron plates 21 having a thickness of 7 mm were welded to the electrode sides of a pair of clamping devices for an electrodialyzer 10 (the bottom sides of the main bars 3A and 3B in FIG. 1) and were subjected to surface shaping.

The gratings used in this example were made of steel and had the main bars in a lateral direction and the crossbars in a longitudinal direction formed at a pitch width of 35 mm and at a pitch width of 40 mm, respectively. The main bars of the gratings used in this example had a thickness of 6 mm.

The paired clamping devices for an electrodialyzer 10 were produced, being divided into two parts of a right-hand clamping member 10A and a left-hand clamping member 10B respectively, and the right-hand clamping member 10A and the left-hand clamping member 10B had a length of 700 mm and a width of 687 mm and had boltholes 15 for claiming formed at pitches of 350 mm therein. When the paired clamping devices for an electrodialyzer 10 were used, when M25 bolts were passed through the boltholes and clamped a unit having stacked chamber frames and ion exchange membranes with a clamping torque of 70N·m (clamping pressure of 1.0 MPa), the chamber frames were subjected to a deflection of 0.4 mm, which exhibited a good result.

The paired clamping device for an electrodialyzer 10 were as lightweight as 55 Kg per one piece in weight during handling such that the paired clamping devices were handled by two persons. The total weight of the paired clamping devices for an electrodialyzer 10 at that time was 220 Kg (=55 Kg×4 pieces) because of requiring totally four pieces of a pair of right-hand clamping member 10A and left-hand clamping member 10B (totally two pieces) for a left side of a unit having stacked chamber frames and ion exchange membranes and another right-hand clamping member 10A and left-hand clamping member 10B (totally two pieces) for a right side of the unit.

### Comparative Example 1

A pair of clamping devices for an electrodialyzer was produced, using iron plates having a thickness of 30 mm, for a unit having stacked chamber frames and ion exchange membranes similar to the unit in Example 1. Each of the clamping devices had dimensions of 1,400 mm in length and 687 mm in width and were configured to have boltholes 15 formed at pitches of 350 mm for clamping.

When the paired clamping devices were utilized to clamp the unit with a clamping torque of 70 N·m (clamping pressure of 1.0 MPa), using M25 bolts, the chamber frames were subjected to a deflection of 1.3 mm, which exhibited a worse result than Example 1. One of the devices weighed as heavy as 220 Kg (total weight was 440 Kg (=220 Kg×2 pieces)) during handling such that the devices were not capable of being handled without using a crane.

### INDUSTRIAL APPLICABILITY

The clamping device for a dialyzer according to the present invention is usable as a clamping device which is readily produced and is inexpensive and lightweight.

This application is a continuation of PCT Application No. PCT/JP2012/077794, filed on Oct. 26, 2012, which is based upon and claims the benefit of priority from Japanese Patent Application No. 2011-237134 filed on Oct. 28, 2011. The contents of those applications are incorporated herein by reference in their entireties.

### REFERENCE SYMBOLS

1A and 1B: Lattice structure
3A and 3B: Main bar
5A and 5B: Crossbar
7A and 7B: Upper end plate
9A and 9B: Lower end plate
10: Device for electrodialyzer
10A: Right-hand clamping member
10B: Left-hand clamping member
11A, 11B, 13A and 13B: Holding member
15: Bolthole
21: Iron plate
23: Discharge side holding member
25: Supply side holding member
31: Discharge port for desalinated liquid
33: Discharge port for concentrated liquid
35: Supply port for desalinated liquid
37: Supply port for concentrated liquid
40: Dialysis-functioning unit
41: Clamping frame (clamping device)
42: Clamping bolt
43: Nut
44: Spring
50: Cation exchange membrane
51: Anion exchange membrane
52: Chamber frame for concentration
53: Chamber frame for desalination
54 and 55: Electrode frame
56: Clamping device

What is claimed is:

1. A clamping device for a dialyzer, which is usable in an dialyzer including chamber frames and ion exchange membranes forming desalination chambers and/or concentration chambers, and electrode frames for sandwiching the chamber frames and the exchange membranes therebetween;
the clamping device including:
a holding member having a supply port and a discharge port for permitting a liquid to be treated to flow through the desalination chambers and the concentration chambers;
a clamping part for clamping the holding member by a certain clamping pressure;
a lattice structure having a contact portion configured to be brought into contact with an electrode frame or be brought into contact with the electrode frame through a certain plate-shaped member such that the lattice structure clamps the electrode frame, the chamber frames and the exchange membranes through the contact portion by clamping at the clamping part; and
the lattice structure having a pitch width of at least 10 mm and at most 50 mm.

2. The clamping device according to claim 1, wherein the holding member and the lattice structure are divided into plural sections, respectively.

3. The clamping device according to claim 1, wherein the clamping device is designed such that the chamber frames are subjected to a deflection of at most 1.5 mm when the clamping part applies a clamping pressure of at least 0.5 MPa.

4. The clamping device according to claim 2, wherein the clamping device is designed such that the chamber frames are subjected to a deflection of at most 1.5 mm when the clamping part applies a clamping pressure of at least 0.5 MPa.

5. The clamping device according to claim 1, wherein the lattice structure is made by machining a grating.

6. The clamping device according to claim 2, wherein the lattice structure is made by machining a grating.

7. The clamping device according to claim 3, wherein the lattice structure is made by machining a grating.

8. The clamping device according to claim 4, wherein the lattice structure is made by machining a grating.

9. A dialyzer including the clamping device defined in any one of claim 1.
